(19) United States
(12) Patent Application Publication
(10) Pub. No.: US 2014/0074596 A1
(43) Pub. Date: Mar. 13, 2014

(54) SYSTEM AND METHOD FOR ASSIGNING AND TRACKING TEMPORARY PHONE NUMBERS FOR ADVERTISEMENT SERVING

(71) Applicant: Chitika, Inc., Westborough, MA (US)

(72) Inventors: Venkateswarlu Kolluri, Shrewsbury, MA (US); Alden DoRosario, South Grafton, MA (US)

(73) Assignee: Chitika, Inc., Westborough, MA (US)

(21) Appl. No.: 13/954,525

(22) Filed: Jul. 30, 2013

Related U.S. Application Data
(60) Provisional application No. 61/699,057, filed on Sep. 10, 2012.

(51) Int. Cl. G06Q 30/02

(52) U.S. Cl. CPC G06Q 30/0246
USPC 705/14.45

(57) ABSTRACT

A system enables tracking of specific ad impressions that are responsible for eliciting specific telephone responses to online ads. Each time the system receives a request from a user to present an advertiser's telephone number in an impression of an ad, the system generates a temporary telephone number for the advertiser. The temporary telephone number lasts for a limited lifetime, during which any incoming telephone call is automatically routed to a POC designated by the advertiser. Whenever a temporary telephone number is generated for an advertiser, the system associates the temporary telephone number with the ad impression in which the temporary telephone number is displayed. Preferably, each temporary telephone number is only presented once during its lifetime, such that each temporary telephone number is only associated with a single ad impression. Thus, any call to a temporary telephone number can only have been elicited by a single ad impression.

### RELATED APPLICATIONS

This application claims priority to, and the benefit of, co-pending U.S. Provisional Application No. 61/699,057, filed Sep. 10, 2012, for all subject matter common to these applications. The disclosure of said provisional application is hereby incorporated by reference in its entirety.

### FIELD OF THE INVENTION

The present invention relates to online advertisements. More particularly, the present invention relates to systems and methods for serving and tracking online ads through the use of temporary telephone numbers.

### BACKGROUND OF THE INVENTION

As use of the Internet continues to increase, online ads have become extremely effective tools for businesses. Many beneficial features and services of online advertising are enabled by tracking information about ad impressions that generate a click or other user response.

As a first example, gathering and tracking information about ad impressions that generate user responses can be used to achieve more effective ad targeting. In particular, each instance of an ad impression can be characterized according to a set of features, herein referred to as “impression data.” The impression data can include the location (e.g., city, state, etc.) of the user to whom the ad was displayed, the browsing activity of the user to whom the ad was displayed (e.g., previously visited web pages, etc.), the time the ad was displayed, profile information of the user to whom the ad was displayed (if available), and the like. By analyzing this and other impression data for a plurality of different ads that have generated a user response (such as a “click”), it is possible to identify opportunities and situations in which the likelihood of an ad generating a user response is high. Future ads then can be displayed more heavily in these identified situations, for which likelihood for user response is found to be high.

As a second example, tracking consumer responses (e.g., clicks) to displayed ads allows an advertising network to provide advertisers with a payment scheme in which the advertisers “pay per click,” commonly referred to as “PPC advertising.” PPC advertising operates as follows: an advertiser provides an advertising network with an ad to display. The advertising network posts the ad on the web pages of various content publishers. Each time the advertiser's ad is clicked by a user, the advertiser is required to pay a fee to the advertising network. For many businesses, PPC advertising (or more generally, pay per response advertising) is a desirable alternative to paying for the number of ad impressions, since in PPC advertising, required payments are more likely to correlate with increased revenue (e.g., due to purchases stemming from the ad clicks).

In online advertising, certain forms of response to ads are more easily tracked than other forms. For example, web-based responses to online ads (e.g., ad clicks) are readily and frequently tracked in existing advertising networks. When a user clicks on an ad being displayed in a search engine results web page and thereby navigates to a website of a business providing the content of the ad, the ad network is immediately notified. As such, the particular impression (and its associated impression data) is immediately associated with the ad click. This allows advertising networks to track how many ad clicks are received, what types of ad impressions are clicked, and the like.

However, other forms of response to online ads are extremely difficult to track. Advertising networks often experience particular difficulty in attempting to track non-web-based forms of response, such as telephone responses to online ads. For example, there are many businesses that do not possess a strong web presence, and which instead use telephone as their primary form of communication (e.g., for booking reservations, conducting payment transactions, describing products/services, etc.). When such a business places an online ad, the ad typically lists the business' telephone number to provide consumers with a way to respond to the online ad. Yet, such a telephone response cannot be linked specifically or even generally to an ad impression simply by examining the state of the telephone call or other readily available information about the telephone call being exchanged in the telephone communication network (e.g., PSTN). Stated differently, traditional telephone communication networks and media do not presently provide information that would enable an advertising network to identify specific phone calls to a listed telephone number as being in response to an ad, much less as being in response to a specific ad impression. This is due in part to the primitive nature of telephones and telephone communication networks as compared to computers and packet-switched networks such as the Internet.

Some advertising networks have attempted to solve this problem of tracking telephone-based ad responses by assigning a distinct telephone number to each company placing an ad. When the advertising network posts an ad for one such company, the advertising network includes the telephone number it has provided to that particular company. All calls that are placed to the telephone number provided in the ad are automatically routed to the company's true telephone number. Accordingly, simple inspection of the call log of the telephone number provided by the advertising network can provide information about phone calls made to that company in response to the online ad.

However, these attempts to track telephone-based ad responses are associated with numerous shortcomings. For example, they fail to track a wide variety of important impression data pertaining to the ad impression that generated the telephone response to the online ad. The existing method of assigning a unique telephone number to each business merely establishes correlation between a phone number and a business. This type of assignment system fails to provide any indication of which specific ad impression generated the phone response, much less the impression data associated with that specific ad impression.

Moreover, the existing attempts to track telephone-based ad responses can potentially harm businesses' branding and advertising efforts. For example, a business wishing to advertise through multiple different advertising networks must be willing to possess several different phone numbers that consumers can regularly and routinely call to reach the company. Yet, instructing multiple different advertising networks to consistently post different regularly accessible phone numbers for a single company can potentially confuse consumers, and can potentially damage efforts to improve consumer recollection of even one of the multiple different phone numbers.

Yet another shortcoming in existing attempts to track telephone-based ad responses is that such attempts fail to establish a system for accurately and fairly charging businesses using a pay-per-response scheme. As applied to telephone communication, pay-per-response advertising charges a business a fee for each phone call to the business that originated from an ad impression provided by the advertising network. Under this payment scheme, existing advertising networks typically assume that any phone calls to the phone number provided by the advertising network originated from an ad impression. Yet, this assumption is clearly erroneous and fails to account for regular customers who initially call the phone number provided by the ad network, and then become accustomed to calling the phone number provided by the advertising network rather than the business' true phone number. Thus, businesses may be unfairly charged for subsequent phone calls by the regular customer, even when the subsequent phone calls are not based on an ad impression. Alternatively, if businesses are only required to pay for calls made by new customers (i.e., as indicated by the appearance of a new phone number on the call log that has not previously called), then this can unfairly favor the company in instances where a consumer calls the company two distinct times, both due to an ad impression.

Accordingly, existing advertising networks fail to provide systems for tracking information pertaining to phone calls originating from ad impressions. As such, existing advertising networks fail to provide many businesses, including many smaller or local businesses that operate without a large web presence, with robust ad targeting or with a fair and accurate pay-per-click payment scheme.)

### SUMMARY

There is a need for systems and methods for accurately tracking information associated with phone calls placed in response to online ads. The present invention is directed toward solutions to address this and other needs, in addition to having other desirable characteristics that will be appreciated by one of skill in the art upon reading the present specification.

In accordance with embodiments of the present invention, a computer-implemented method for tracking advertisements includes receiving, through an input device and from a user device, a request to present a telephone number on the user device in conjunction with an impression of an advertisement. Based on the received request, at least one processor assigns a telephone number to an advertiser associated with the advertisement, the assigned telephone number having an assignment lifetime during which any incoming telephone call to the assigned telephone number is automatically routed to a point of contact of the advertiser. At least one processor associates the assigned telephone number with the impression of the advertisement in one or more non-transitory machine readable storage devices. An output device outputs the assigned telephone number to the user device, whereby the assigned telephone number is caused to be displayed in conjunction with the impression of the advertisement.

In accordance with aspects of the present invention, the step of assigning the telephone number can include selecting a currently unassigned telephone number from a plurality of assignable telephone numbers in the one or more non-transitory machine readable storage devices. During the assignment lifetime of the assigned telephone number, the assigned telephone number can be only caused to be displayed in conjunction with a predetermined quantity of advertisement impressions. The predetermined quantity of advertisement impressions can be one advertisement impression. The assignment lifetime can automatically expire upon one or more predetermined criteria being satisfied. The one or more predetermined criteria can include passage of a predetermined amount of time. The one or more predetermined criteria can include a predetermined quantity of telephone calls being placed to the assigned telephone number. Prior to the step of receiving the request to present the telephone number, an output device can output the advertisement to produce the impression; wherein the request to present the telephone number is received as a result of a selectable indicator included in the advertisement being selected on the user device. Simultaneous with the step of outputting the assigned telephone number, an output device can output the advertisement to produce the impression of the advertisement.

In accordance with embodiments of the present invention, a computer-implemented advertisement system can include an input device configured to receive requests from user devices. At least one non-transitory machine readable storage device can be configured to store information pertaining to assignments of telephone numbers. An assignment module can be configured to cause at least one processor to assign a telephone number to an advertiser based on a received request from a user device to present a telephone number on the user device in conjunction with an impression of an advertisement associated with the advertiser. A tracking module can be configured to cause at least one processor to associate the assigned telephone number with the impression of the advertisement in the at least one non-transitory machine readable storage device. An output device can be configured to output the assigned telephone number to the user device, such that the assigned telephone number is presented on the user device. The computer-implemented advertisement system can be configured such that the assigned telephone number has an assignment lifetime, during which any incoming telephone call to the assigned telephone number is automatically routed to a point of contact of the advertiser assigned to the assigned telephone number.

In accordance with aspects of the present invention, the assignment module can be configured to assign the telephone number by selecting a currently unassigned telephone number from a plurality of assignable telephone numbers stored in the at least one non-transitory machine readable storage device. The computer-implemented advertisement system can be configured in such a way that during the assignment lifetime of the assigned telephone number, the assigned telephone number is only caused to be displayed in conjunction with a predetermined quantity of advertisement impressions. The predetermined quantity of impressions can be one impression. The computer-implemented advertisement system can be configured in such a way that the assignment lifetime of the assigned telephone number automatically expires upon one or more predetermined criteria being satisfied. The one or more predetermined criteria can include passage of a predetermined amount of time. The one or more predetermined criteria can include a predetermined quantity of telephone calls being placed to the assigned telephone number. The computer-implemented advertisement system can be configured to output, through the output device and to the user device, the advertisement with a selectable indicator that, when selected on the user device, results in the user device sending the request to present the telephone number to the computer-implemented advertisement system. The computer-implemented advertisement system can be configured to output, through the output device and to the user device, the advertisement with the assigned telephone number, thereby presenting the assigned telephone number in conjunction with the impression of the advertisement. An ad serving module can be configured to cause at least one processor to select advertisements to display to user devices and configured to cause at least one output device to output the selected advertisements to the user devices. The user device has a browser client configured to receive the outputted selected advertisements.

### BRIEF DESCRIPTION OF THE FIGURES

These and other characteristics of the present invention will be more fully understood by reference to the following detailed description in conjunction with the attached drawings, in which:

FIG. 1 is an illustrative diagram of a system for serving and tracking online ads, according to an example embodiment of the present invention;

FIG. 2 is an illustrative diagram of information that can be stored in the data storage of FIG. 1, according to aspects of the present invention;

FIG. 3 is a flow chart of a method for serving and tracking ads, according to an example embodiment of the present invention;

FIG. 4 is a flow chart of a method for performing a step of serving an ad with a mechanism for requesting a telephone number of an advertiser, according to embodiments of the present invention;

FIG. 5 is a flow chart of a method for performing a step of generating a temporary telephone number for an advertiser, according to aspects of the present invention;

FIG. 6A is a screen depiction of an interactive display presenting a plurality of ads, each accompanied by a selectable indicator, according to aspects of the present invention;

FIG. 6B is a screen depiction of the display of FIG. 6A, subsequent to clicking one of the selectable indicators, according to aspects of the present invention; and

FIG. 7 is an illustrative diagram of a computing device for implementing the system of FIG. 1, according to aspects of the present invention.

### DETAILED DESCRIPTION

An illustrative embodiment of the present invention relates to an advertisement system for tracking and identifying specific ad impressions that are responsible for eliciting specific telephone responses to online ads. In particular, each time the advertisement system receives a request from a user device to present an advertiser's telephone number in an impression of an ad, the advertisement system generates a temporary telephone number for the advertiser. The temporary telephone number is presented to the user in the impression of the ad, thereby enabling the user to place a telephone call to the advertiser. The advertiser's temporary telephone number lasts for a limited period of time (referred to herein as its “telephone lifetime”), during which any telephone call placed to the temporary telephone number is automatically routed to a point of contact (POC) designated by the advertiser to receive responses to the ad. As non-limiting examples, the point of contact can be a front desk reception telephone line, a call center telephone line, an automated call menu, the advertiser him/herself, or any other POC. The telephone lifetime can automatically end once one or more predetermined criteria are met. For example, the telephone lifetime can automatically end after a predetermined amount of time has passed, but in most instances will end within minutes of its initiation (e.g., thirty minutes or less).

Furthermore, each time the advertisement system generates a temporary telephone number for an advertiser, the advertisement system associates (e.g., in data storage) the temporary telephone number with the particular ad impression in which the temporary telephone number is displayed. Preferably, each temporary telephone number is only presented once during its telephone lifetime, such that each temporary telephone number is uniquely associated with a single ad impression in which the temporary telephone number was presented. Thus, in such embodiments, any call to a temporary telephone number can only have been elicited by a single ad impression. Accordingly, the unique association between ad impressions and temporary telephone numbers allow any telephone call placed to a temporary telephone number during its telephone lifetime to be traced by the advertisement system back to a particular ad impression that elicited the telephone call.

As utilized throughout herein, the terms “ad” and “advertisement” are interchangeable and are intended to have the same meaning.

As one example, the temporary telephone numbers can be generated by temporarily assigning a plurality of assignable telephone numbers to the advertisers. Each telephone assignment remains in effect for a period of time referred to herein as an “assignment lifetime,” during which the assignable telephone number is assigned to a specific advertiser and serves as a temporary telephone number for the advertiser. The assignment lifetime of a telephone assignment thus corresponds to the telephone lifetime of a corresponding temporary telephone number. The assignment lifetime can automatically expire upon one or more criteria being satisfied. For example, in one embodiment, the assignment lifetime of a telephone assignment automatically expires once a predetermined amount of time (e.g., thirty minutes) has passed since the telephone assignment was instantiated. When the assignment lifetime of the assignable telephone number expires, the assignment is automatically revoked or terminated by the advertisement system, and the advertiser's temporary telephone number ceases to exist. Once a telephone assignment has been revoked by the advertisement system, the formerly assigned assignable telephone number is available for reassignment. Thus, over time, as the advertisement system continues to receive requests to present advertisers' telephone numbers in impressions of ads, the assignable telephone numbers follow a pattern of being assigned, revoked, reassigned, revoked, etc.

In one embodiment, the particular telephone number that is temporarily assigned to the advertiser is selected from a plurality of currently unassigned telephone numbers contained in a database of assignable telephone numbers. Once the assignment lifetime of the assignable telephone number expires, the assignable telephone number is “repossessed” (i.e., the assignment of the assignable telephone number is revoked) and the assignable telephone number is indicated as assignable within the database.

In general, any suitable mechanism for presenting the temporary telephone numbers can be used. For example, in one embodiment described in greater detail herein, an online ad is displayed with a selectable icon, such as an image of a telephone. In an impression during which the online ad is shown to a user (e.g., on a web page), the user can select the selectable icon (e.g., by clicking). Upon a user clicking the icon in an ad, the user further can be presented with a temporary telephone number for the advertiser and with a warning message indicating that the displayed temporary telephone number will expire, e.g., within the predetermined amount of time. In such embodiments, upon the user selecting the selectable icon, the advertisement system can: (a) generate a temporary telephone number for the advertiser by temporarily assigning the advertiser one of the assignable telephone numbers; (b) cause the advertiser's temporary telephone number to be displayed the user on his/her user device (e.g., in the ad, in a pop-up window, in a banner, etc.); and/or (c) track possible future telephone responses to the ad by associating (e.g., in data storage), the telephone assignment with the particular ad impression in which the advertiser's temporary telephone number is being presented.

Histories of the telephone assignments can be tracked, for example in logs (e.g., server logs, etc.), databases, and/or any other suitable record-keeping mechanisms or data storage. For example, in some embodiments in which temporary telephone numbers are generated through temporary assignments of assignable telephone numbers, the following information is tracked for each telephone assignment that is made: (a) an assignable telephone number selected to serve as the temporary telephone number in the telephone assignment; (b) an impression of an ad in which the temporary telephone number is displayed; and (c) a time at which the telephone assignment occurred (e.g., implemented using a timestamp). These telephone assignment histories can allow greater tracking capability of users' telephone responses to online ads, by enabling particular telephone calls placed to the assignable telephone numbers to be linked to specific particular ad impressions (e.g., depending on the time that the telephone call was placed).

As described previously herein, in certain illustrative embodiments according to the present invention, each temporary telephone number is presented only once during its telephone lifetime. Accordingly, in such embodiments, once a temporary telephone number is displayed to a user, the temporary telephone number is not displayed a second time (to any user) during its telephone lifetime. More specifically, in such embodiments, each received request to present an advertiser's contact information causes the advertisement system to generate a temporary telephone number that is different from any other temporary telephone number in existence at that time. Thus, in embodiments utilizing assignable telephone numbers to generate the temporary telephone numbers, each telephone assignment is associated with only one ad impression and thus only one set of impression data. This can be beneficial, for example, in enabling each telephone response placed to an assignable telephone number to be distinctly and precisely correlated with a single, specific ad impression.

Accordingly, in embodiments of the present invention, the use of temporary telephone numbers can enable exact correlations to be established between (a) specific impressions of ads, and (b) specific telephone responses to the ads. More particularly, in accordance with some embodiments of the present invention, the advertisement system is configured to identify an exact ad impression that resulted in a specific telephone response to an online ad. As such, the advertisement system according to embodiments of the present invention also can be configured to correlate specific telephone responses with specific impression data (e.g., “Acme Corp. received a telephone call on April 18 at 5:34 pm. This telephone call originated from an impression of Acme Corp's ad for carpeting services shown on bostoncarpet.com at 5:24 pm to a user located in Boston, Mass. who had navigated to bostoncarpet.com from a search engine in which the terms ‘carpet+boston’ were searched.”). In embodiments utilizing assignable telephone numbers, such correlations can be established by (a) matching the dialed telephone number of a single telephone response to a particular assignable telephone number, and (b) matching the call time of the single telephone response with a time during which the particular assignable telephone number was assigned. The ad impression(s) and the set(s) of impression data associated with the matching telephone assignment indicate the particular ad impression that produced the telephone response.

In addition to more effectively tracking telephone responses to advertisers' online ads, embodiments of the present invention utilizing assignable telephone numbers achieve yet another advantage. The required stock of assignable telephone numbers (i.e., the quantity of assignable telephone numbers required to meet advertisers' usage needs) of the advertisement system according to embodiments of the present invention is in many cases significantly less than the required stock of assignable telephone numbers for existing systems that utilize static and permanent assignment schemes. Existing systems meet advertisers' usage needs by reserving a fixed quantity of assignable telephone numbers per advertiser for whom ads are being placed (e.g., one assignable telephone number per advertiser). On the other hand, in embodiments of the present invention, the required stock of assignable telephone numbers can be equal to or slightly greater than the maximum number of users requesting advertisers' telephone numbers at any given point in time. In many instances, this maximum value may be substantially lower than the total number of advertisers for whom ads are being placed. In effect, embodiments of the present invention can achieve a reduction in the required stock of assignable telephone numbers by “repurposing” assignable telephone numbers that a conventional static assignment system would have assigned to companies currently receiving no telephone calls. Consequently, a greater number of advertisers can be accommodated using fewer assignable telephone numbers.

Yet another potential advantage of certain embodiments of the present invention is that the limited telephone lifetimes of the temporary telephone numbers (e.g., which can be presented to users) can psychologically affect users by creating a sense of urgency to place the telephone call before the temporary telephone number expires. Thus, by psychologically encouraging users to make the call, the advertisement system according to embodiments of the present invention potentially can increase the quantity of responses an advertiser will receive to an online ad.

As another possible advantage, in embodiments where users are informed of (e.g., presented with a warning indicating) the temporary nature of the advertisers' temporary telephone numbers, companies are unconstrained by the expectations conventionally associated with permanently assigned telephone numbers. For example, when users are presented with an advertiser's permanent telephone number, there is a reasonable expectation that at least some of the users will attempt to remember the telephone number for future reference. Thus, to cater to such users' perceived tendencies to rely on memory when placing a call, some companies generate a single memorable telephone number that can be used to contact any department and any point of contact within the company. This can result in the use of automated call menus, secretaries/front desk workers, and the like, to transfer incoming calls to the appropriate department, etc. This tends to extend the length of the phone call, which many consumers find undesirable. Accordingly, embodiments of the present invention avoid such requirements for a single telephone number and thus remove the need for call transferring services (e.g., automated call menus, secretaries/front desk workers, and the like). In particular, in embodiments of the present invention where temporary telephone numbers are presented with a warning message indicating that the temporary telephone number will soon expire, users will no longer attempt to remember the telephone number. By removing the expectation that users will rely on memory, multi-departmental companies are enabled to designate specific departmental phone numbers as the point of contact for specific online ads. Branding efforts therefore can be focused on other features, such as the company's trade name.

For example, in accordance with one example embodiment of the present invention, a small subcontracting business that provides both carpentry and plumbing services may separately advertise its two services in two different online ads (e.g., “Acme Plumbing Services” and “Acme Carpentry!”), and further may designate a different point of contact (e.g., a plumber and a carpenter, respectively) for each of the two online ads. A user viewing one of the two ads thus can place a telephone call directly to the appropriate point contact (e.g., the plumber or the carpenter), without requiring any call transferring. Instead, the subcontracting business can simply provide two different online ads that separately advertise the two services (plumbing and carpentry), and further may provide a different telephone number as the point of contact for receiving responses to each of the two online ads.

In addition, according to certain embodiments of the present invention, systems provided herein can enable advertisers (e.g., online service entities) to access, sort, filter, and otherwise analyze the histories and information associated with their temporary telephone numbers. This can be useful, for example, in determining the ways in which the online information service is being utilized by users and in determining whether the online information service is being used effectively. For example, such information may be useful in determining which web pages in the online service need improvement and/or expansion so as to avoid an excessive number of telephone calls.

Notably, the benefits achieved from providing advertisers with temporary telephone numbers are unexpected and contradict established teachings in the art that advertised telephone numbers generally should be permanent and long lasting. As one example, there are many teachings in the art suggesting that permanent telephone numbers are important branding tools for companies. This is evidenced by the wide range of jingles, rhymes, and other advertisements that feature a company's telephone number in an effort to attract additional calls by making the telephone number more memorable. As a second example, longstanding teachings in the art suggest that telephone numbers should be permanent since customers frequently save telephone numbers they have previously dialed. For instance, many users store previously dialed telephone numbers as contact entries (e.g., in their mobile phones), or in other telephone directories. Additionally, many users place calls by retrieving previously dialed telephone numbers from recent call history logs (e.g., on their mobile phones). Accordingly, the use of temporary telephone numbers contradicts these and yet other established teachings in the art, which assume that permanence is a required feature of a telephone number when advertising the telephone number to customers and potential customers.

Although certain embodiments are described herein with reference to online (i.e., Internet-based) ads, the present invention is not so limited. One of skill in the art will appreciate a wide variety of other types of communications networks besides the Internet and the World Wide Web across which ads can be displayed to users. All such alternatives and modifications are contemplated within the scope of the present invention. Any suitable form and communication network for serving and tracking ads can be implemented with embodiments with the present invention.

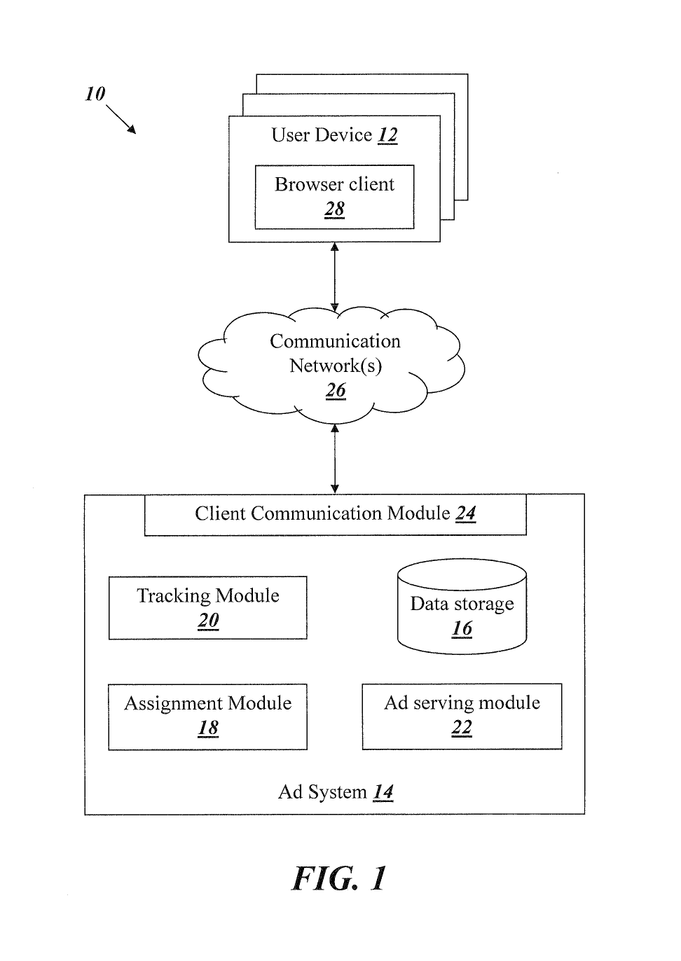

FIGS. 1 through 7, wherein like parts are designated by like reference numerals throughout, illustrate example embodiments of systems and methods for serving and tracking ads through the user of temporary telephone numbers, according to the present invention. Although the present invention will be described with reference to the example embodiments illustrated in the figures, it should be understood that many alternative forms can embody the present invention. One of skill in the art will additionally appreciate different ways to alter the parameters of the embodiments disclosed, such as the size, shape, or type of elements or materials, in a manner still in keeping with the spirit and scope of the present invention.

FIG. 1 is a schematic diagram of a system 10 for providing and tracking online ads, according to an example embodiment the present invention. The system 10 includes one or more user devices 12 and an advertisement system 14. The user devices 12 and the advertisement system 14 are in communication with one another over one or more communication networks 26, such as, e.g., the Internet. Each user device 12 can include a browser client 28 configured to retrieve, present, and navigate web pages. The advertisement system 14 can include data storage 16 (e.g., databases, data stores, logs, etc.), an assignment module 18, a tracking module 20, an ad serving module 22, and a client communication module 24. The data storage 16 can store a wide variety of information and data, including a plurality of assignable telephone numbers and a plurality of advertisements, as will be described in greater detail herein. The assignment module 18 is configured to generate a temporary telephone number for an advertiser by assigning the advertiser one of the assignable telephone numbers. The assignment module 18 further can be configured to revoke the assignment of assignable telephone numbers once their respective assignment lifetimes have expired. The tracking module 20 is configured to track information pertaining to the temporary assignments of the assignable telephone numbers, e.g., by storing the information in one or more logs in the data storage 16. The ad serving module 22 is configured to serve ads to users on the user devices 12 based on requests sent by the browser client 28 to the advertisement system 14. The ad serving module 22 can include any suitable advertisement serving technology (e.g., one or more ad servers), as would be appreciated by one of skill in the art upon reading the present specification. The client communication module 24 is configured to receive requests (e.g., HTTP requests) from the user device 12 and is configured to send ads to the browser client 28 of the user device 12.

The user device 12 includes at least one presentation device or component configured to display the web pages loaded by the browser client 28 and ads sent from the advertisement system 14. The user device 12 generally can be any computing device, including, as illustrative examples, a personal computer, a workstation computer, a laptop, a desktop, a hand-held device, a mobile device, a cellular device, a smartphone device, a tablet computer, a palmtop computer, a set top box, or any other computing devices that includes at least one presentation device, as described in greater detail herein. The advertisement system 14 can include one or more server devices, one or more non-transitory computer readable storage devices, and/or any other suitable computing device(s), as described in greater detail herein and as would understood by those of skill in the art upon reading the present specification. For example, in some embodiments, the advertisement system 14 is implemented such that the ad serving module 22 and the client communication module 24 are included on one or more servers, the assignment module 18 and the tracking module 20 are included on one or more assignment and/or tracking servers, and the data storage 16 is stored in one or more storage devices (e.g., stored on non-transitory machine readable media included therein).

In general, the assignment module 18, the tracking module 20, the ad serving module 22, the client communication module 24, and the browser client 28 can be implemented as computer executable instructions (e.g., software) stored on non-transitory machine readable media that, when executed by at least one processor, result in the functionality described herein. One of skill in the art will appreciate a wide variety of suitable ways to implement the modules and components of the system 10 upon reading the present specification. All such alternatives and modifications are contemplated within the scope of the present invention.

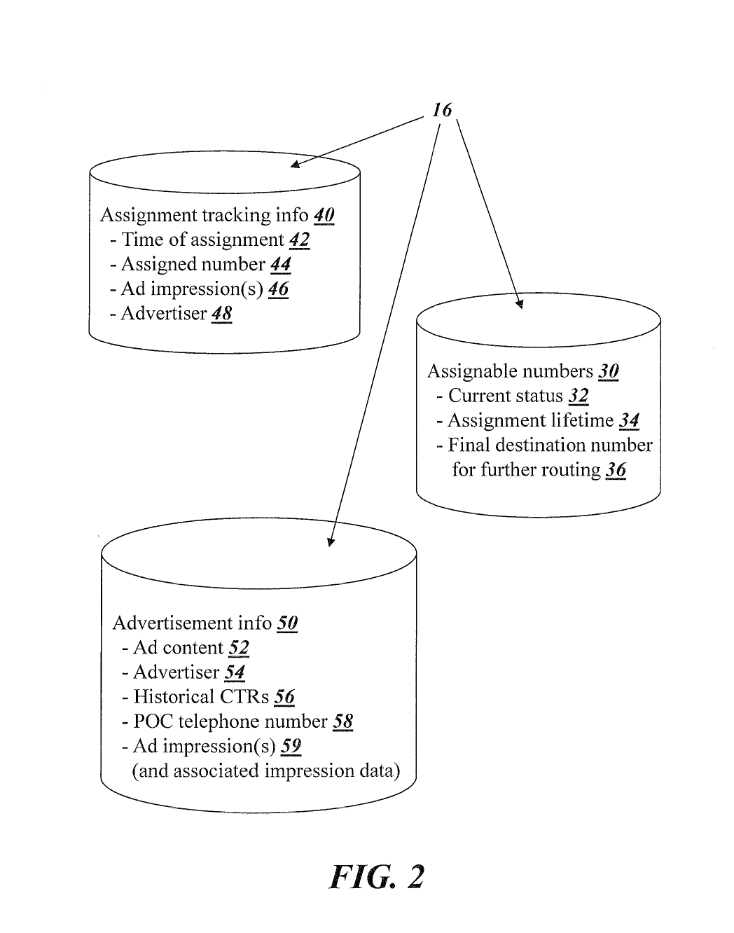

The data storage 16 generally can include a wide variety of information and data. FIG. 2 depicts some non-limiting examples of the information that can be included in the data storage 16. In particular, the data storage 16 can include (a) a plurality of assignable telephone numbers 30 configured to be assigned to advertisers, (b) assignment tracking information 40 pertaining to past and/or present assignments of the assignable telephone numbers 30 that have been made, and (c) advertisement information 50. Furthermore, the data storage 16 can take the form of a single component, or can be implemented as multiple components capable of the requisite communication to transfer the information and data as required by the present invention, as would be understood by those of skill in the art.

In the data storage 16, each assignable telephone number 30 can be associated with a current status indication 32, a remaining amount of assignment lifetime 34 (if the assignable telephone number 30 is currently assigned to an advertiser), and a final destination telephone number 36 for further routing incoming calls placed to the assignable telephone number 30 (if the assignable telephone number 30 is currently assigned to an advertiser). Each current status indication 32 can indicate whether an assignable telephone number 30 is currently assigned or is currently unassigned to an advertiser. The remaining amount of assignment lifetime 34 can indicate a maximum amount of time remaining until the assignable telephone number 30 will be repossessed or revoked. The final destination telephone number 36 can indicate a telephone number to which all incoming calls placed to the assignable telephone number 30 will be forwarded/routed.

The assignment tracking information 40 can include information about past and/or present telephone assignments that the advertisement system 14 has made. The assignment tracking information 40 can be stored, for example, in one or more log files. For each assignment that is made by the advertisement system 14, the log file(s) can include one or more of the following pieces of information: (a) a time of assignment 42 indicating the time at which the assignable telephone number 30 was assigned to the advertiser; (b) an identification of an assigned telephone number 44, which indicates a specific one of the plurality of assignable telephone numbers 30 that was assigned to the advertiser; (c) one or more associated ad impression(s) 46 identifying in which of the particular ad impression(s) 59 the assigned telephone number 44 was included; and/or (d) an identification of an advertiser 48, which indicates a particular one of the advertisers 48 providing the content of the ad shown in the ad impression 46. In illustrative embodiments, all of the above-described information (a) through (d) is stored in the one or more log files for each telephone assignment that is made by the advertisement system 14.

The advertisement information 50 can include a plurality of advertisements from which the advertisement system 14 may choose when selecting an ad to serve on one of the user devices 12. As such, the advertisement information 50 can include a wide variety of information conventionally utilized in advertising networks for enabling such ad serving functionality. For example, for each advertisement stored in the data storage 16, the advertisement information 50 can include advertisement content 52, an advertiser 54 that provided the advertisement content 52, and the advertisement's historical data, e.g., historical click-through-rates (CTRs) 56. One of skill in the art will appreciate yet other conventional advertisement information 50 that additionally or alternatively can be included in the data storage 16 upon reading the present specification. All such additions and alternatives are contemplated within the scope of the present invention. In addition to this conventionally utilized information, the advertisement information 50 may also include a telephone phone number 58 for the POC designated by the associated advertiser 54, to which ad responses will be routed. The advertisement information 50 in the data storage 16 may also include, for each represented ad, impressions 59 of the ad and associated impression data for each impression.

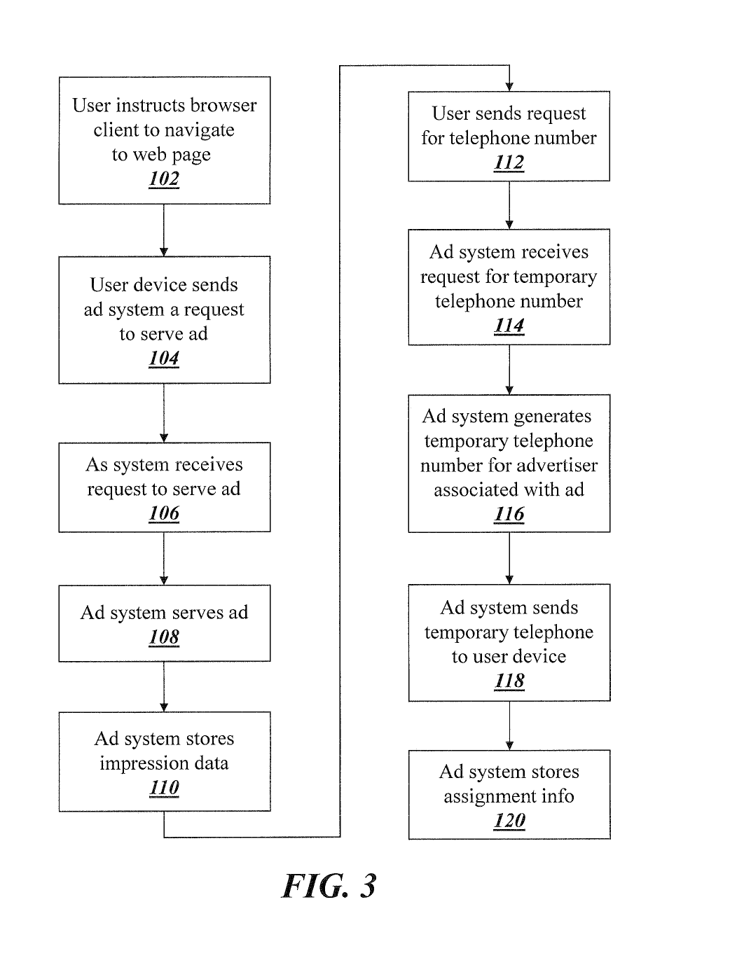

One example embodiment of a method by which the system 10 operates will now be described with reference to FIG. 3. A user can instruct the browser client 28 of his or her user device 12 to navigate to a web page (step 102). If the web page is configured to coordinate with the advertisement system 14 in serving ads, then the browser client 28 will instruct the user device 12 to send the advertisement system 14 a request to serve an ad (step 104). The user device 12 sends the request to serve an ad through at least one output device, across the communication network(s) 26. The advertisement system 14 thus receives, through at least one input device, the request from the user device 12 to serve an ad (step 106). Based on the received request for an ad, the ad serving module 22 serves the ad (step 108). The ad served by the advertisement system 14 is configured to enable the user viewing the ad to request a telephone number for the advertiser 54 providing the displayed ad content 52. For example, the ad can include a selectable indicator (e.g., a telephone icon) that, when selected, causes a request for a telephone number of the associated advertiser 54 to be sent to the advertisement system 14.

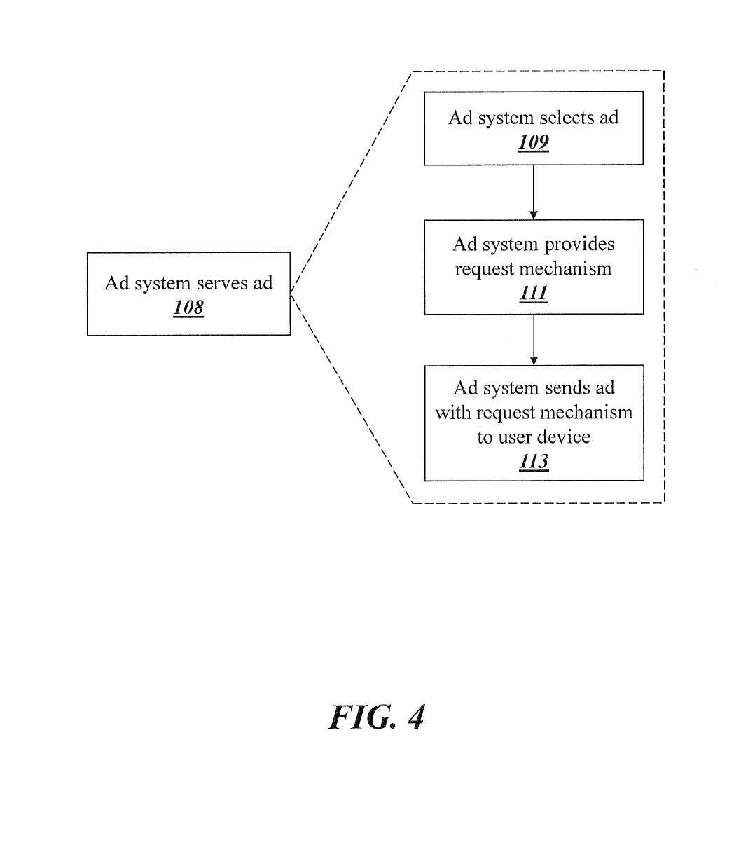

FIG. 4 depicts an example embodiment for performing step 108 of serving the ad. The ad serving module 22 selects, using at least one processor, an ad from the plurality of ads in the data storage 16 (step 109). For example, step 109 can include analyzing historical CTRs 56 for the ad, analyzing a total number of impressions for the ad, and the like. In addition to selecting an ad, the advertisement system 14 provides a telephone number request mechanism in the ad that enables the user to send a request for a telephone number of the advertiser 54 associated with the ad (step 111). For example, the telephone number request mechanism can include a selectable indicator (e.g., a telephone icon) that, when clicked, causes a request for a telephone number of the advertiser 54 associated with the ad to be sent to the advertisement system 14. The advertisement system 14 sends, through at least one output device, the selected ad with the request mechanism to the user device 12 (step 113). The selected ad with the request mechanism are transmitted over the communication network 26 and received by the user device 12, whereupon the user device presents the ad with the request mechanism.

Upon the ad being presented to the user on at least one presentation component or device of the user device 12, an impression of the ad is produced. The ad impression is associated with impression data, such as the time at which the ad was displayed, the IP address of the user device 12 viewing the ad, the referrer (e.g., the “HTTP referer”) associated with the request from the user device 12 to serve the ad, and other impression data. Returning now to FIG. 3, this impression data for the ad impression can be stored by the advertisement system 14 in the data storage 16, using one or more processors (step 110). Once the ad has been served and displayed to the user device 12, the user can use the telephone number request mechanism (e.g., can select the selectable indicator) to send a request for a telephone number of the advertiser 54 associated with the ad to the advertisement system 14 (step 112). More specifically, the user device 12 sends the request for the telephone number through at least one output device and across the communication network(s) 26 to the advertisement system 14. The request for a temporary telephone number is received by the advertisement system 14 through at least one input device (step 114). Based on the received request, the advertisement system 14 generates, using at least one processor, a temporary telephone number for the advertiser 54 associated with the ad currently being viewed by the user (step 116). The advertisement system 14 sends, through at least one output device, the generated temporary telephone number across the communication network(s) 26 to the user device 12 (step 118). This causes the temporary telephone number to be displayed to the user on at least one presentation device included in the user device 12. The tracking module 20 of the advertisement system 14 also stores, using at least one processor, assignment tracking information 40 (e.g., in the data storage 16) pertaining to the telephone assignment (step 120). For example, step 120 can include storing any of the assignment tracking information 40 previously described herein, including a time of assignment 42, an assigned telephone number 44, and an associated ad impress ion(s) 46.

In some embodiments, the advertisement system 14 further is configured to track instances of telephone response to the online ads by tracking telephone calls placed to the assignable telephone numbers 30. For example, the advertisement system 14 can include call routing and/or forwarding devices, such as a private branch exchange (PBX), or voice over internet protocol (VOIP) phone systems, etc. Each time a telephone call is made by a user to an assignable telephone number 30 that has been temporarily assigned to an advertiser 54, the tracking module 20 can record information about the telephone call, such as date of call, time of call, length of call, the telephone number used by the user to place the call (if available), the assignable telephone number 30 to which the call was placed, record the call itself, provide text translation or conversion of voice to textual transcript for storage together with the audio recording, or the like. By tracking the foregoing call information (e.g., in a call log stored in the data storage 16), the advertisement system 14 can be configured to provide GUIs enabling advertisers to access, from their computing devices, one or more of: specific historical reports showing telephone calls placed to their temporary telephone numbers, the ads to which the telephone calls were in response, the ad impression that originated the response, impression data associated with the ad impression, and the telephone numbers used by the users to place the telephone calls (if available).

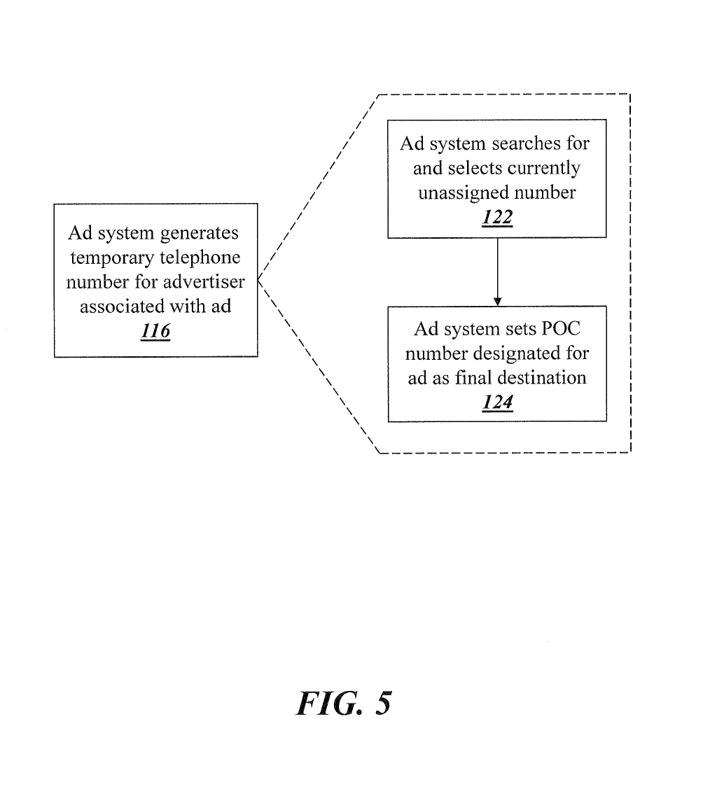

FIG. 5 depicts an example embodiment according to the present invention of a method for executing step 116 of generating the temporary telephone number for the advertiser 54 associated in the data storage 16 with the ad being shown. In particular, the assignment module 18 can perform step 116 by assigning one of the assignable telephone numbers 30 to the advertiser 54 providing the content of the ad. This can be performed in the following manner, in accordance with a further example embodiment of the present invention. The assignment module 18 can use at least one processor to search for and select an assignable telephone number 30 that is currently indicated as unassigned (step 122). Furthermore, in step 122, the search for a suitable assignable telephone number 30 can additionally be constrained by an area code indicating a geographical area that is near or contains a stored location of the advertiser 54. Accordingly, in step 122, the assignment module 18 can select an assignable telephone number 30 currently that is indicated as unassigned and that has an area code indicating an appropriate geographical region relative to the stored location of the advertiser 54. Upon selecting the currently unassigned telephone number 30, the status of the currently assigned telephone number 30 can change to ‘assigned.’ Step 116 may also include the assignment module 18 using at least one processor to retrieve the POC telephone number 58 associated with the ad being displayed to the user device 12 and setting the retrieved POC telephone number 58 as a final destination to which all incoming calls placed to the selected assignable telephone number 30 should be routed/forwarded (step 124).

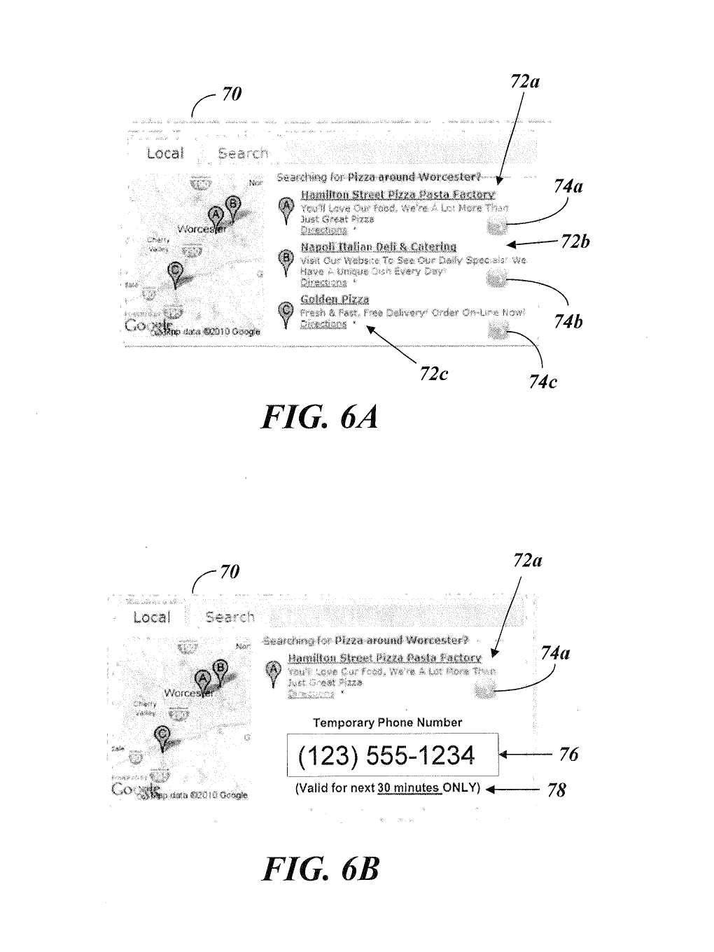

FIG. 6A depicts an example embodiment of an interactive display 70 (e.g., a GUI) presented by the browser client 28 on a presentation device included in the user device 12. The display 70 includes three advertisements 72a, 72b, 72c. Each advertisement 72a, 72b, 72c presents information about a different Italian/pizza restaurant. In the display 70, each advertisement 72a, 72b, 72c includes a selectable indicator 74a, 74b, 74c. In the example embodiment of FIG. 6A, each selectable indicator 74a, 74b, 74c is a telephone icon.

Once a user selects the selectable indicator 74a for the top advertisement 72a, the user is presented with a temporary telephone number 76, as illustrated in FIG. 6B. In the example embodiment of FIG. 6B, the temporary telephone number 76 is represented as “(123) 555-1234.” In addition to displaying the temporary telephone number 76, the user selecting the selectable indicator 74a causes a warning indicator 78 to be presented in the display 70. The warning indicator 78 indicates that the temporary telephone number 76 for the advertiser 54 (in this ease, the temporary telephone number 76 for “Hamilton Street Pizza Pasta Factory”) will expire within a predetermined amount of time (e.g., within 30 minutes).

The warning indicator 78 can embody any suitable form in the display 70, as will be readily appreciated by one of skill in the art upon reading the present specification. For example, in one embodiment, the warning indicator 78 is a text statement associated with the contact telephone link. In another embodiment, the warning indicator 78 is an animated or active display element (e.g., flashing text). In other embodiments, the warning indicator 78 is an active display element including other elements with text or without text, such as active graphics, photographs or images suggesting a warning (e.g., an hourglass with a stream of sand), an animated countdown or clock graphic, or other active display element indicating or suggesting a warning of time passing or expiring.

In some embodiments, the temporary telephone number 76 and/or the warning indicator 78 is selectable and is configured to instruct the user device 12 to place a call to the temporary telephone number 76 upon selection thereof.

In some such embodiments, the selection of the selectable temporary telephone number 76 and/or warning indicator 78 can result in software installed on the user device 12 identifying that a telephone response to an ad has been initiated, and tracking the telephone call event (e.g., tracking information such as the time of call, date of call, and the like). This information can be sent, e.g., to the advertisement system 14 for recordation in the data storage 16. While the information may readily be tracked at the server side of the process, that may not always be the case (e.g., in the instance where a user initiates a call but cancels the action before completing the connection to a sufficient degree for the advertisement system 14 to recognize and record the call activity).

The display 70, the advertisements 72a, 72b, 72c, the selectable indicators 74a, 74b, 74c, the temporary telephone number indicator 76, and the warning indicator 78 of FIGS. 6A and 6B are illustrative and in no way limit embodiments of the present invention. One of skill in the art will appreciate a wide variety of other types of displays, advertisements, and selectable indicators that can be utilized upon reading the present specification. All such alternatives and modifications are contemplated within the scope of the present invention. Any suitable display, advertisements, and selectable indicators can be implemented with embodiments of the present invention.

In accordance with one embodiment, the data storage 16 of the advertisement system 14 includes a database of “device fingerprints” (e.g., unique strings) that enable the advertisement system 14 to identify the specific types of the user devices 12 with which it is communicating. For example, the data storage 16 can include device fingerprints for any one or more of the following: a tablet computer, a handheld device, a smartphone device, a desktop computer, particular brands or manufacturers thereof, and the like. Accordingly, the advertisement system 14 can be configured to provide each user device 12 with advertisements (e.g., 72a, 72b, 72c), selectable indicators (e.g., 74a, 74b, 74c), temporary telephone numbers (e.g., 76), and warning indicators (e.g., 78) appropriately adapted for the type of the user device 12 (e.g., having appropriate size, formatting, layout, etc.).

Advertisers providing ad content 52 to the advertisement system 14 can be enabled to access (e.g., view, filter, sort, etc.) information contained in the data storage 16. For example, the advertisement system 14 can provide a GUI that enables each advertiser to generate, from his/her computing device, one or more reports summarizing statistics on his/her ads and/or on telephone responses to his/her ads (e.g., performance statistics, etc.). For example, advertisers can be enabled to request and access summaries of: (a) the percentage of impressions of the advertiser's ads that resulted in a telephone response to the ad; (b) for each telephone response to one of the advertiser's ads, impression data characterizing the ad impression that originated the telephone response; and/or (c) for each telephone response to one of the advertiser's ads, call information characterizing the telephone responses to the advertiser's ads. The reports can be generated by analyzing, sorting, filtering, or otherwise manipulating or retrieving the advertisement information 50 for the advertiser's ads, the assignment tracking information 40 for assignments made based on impressions of the advertiser's ads, and/or call information pertaining to telephone responses to the advertiser's ads. In addition, information relating to specific statistics related to the actual call content (e.g., the number of calls where “credit card” was mentioned or the number of calls where “wrong number” was mentioned).

Upon reading the present specification, one of skill in the art will appreciate a wide variety of other types of analyses, reports, and summaries that can be provided to the advertisers based on the information collected by the advertisement system 14 and/or stored in the data storage 16. Furthermore, one of skill in the art will readily appreciate a wide variety of ways and GUIs suitable for presenting such analyses, reports, and summaries to advertisers upon reading the present specification. All such alternatives and modifications are contemplated within the scope of the present invention. The present invention is not limited to the examples provided herein.

As described previously herein, in some embodiments, the advertisement system 14 internally hosts call routing by providing various routing equipment and devices suitable for receiving incoming calls to the assignable telephone numbers 30 and routing each incoming call to the appropriate designated POC. In such embodiments, for each incoming telephone call, the advertisement system 14 can be configured to generate an automated message presenting some or all of the available call information and/or impression data associated with the call. The automated message can be a brief audio message that precedes the conversation with the user responding to the ad. For example, once the advertiser's POC answers the telephone, the automated message can be played to the advertiser's POC over the phone just prior to connecting the user to the advertiser. Upon completion of the automated message, the advertiser's POC can be automatically connected to the user placing the telephone call.

For example, consider a user (a) that searches the terms “root canal” in a search engine website such as Yahoo.com, (b) clicks on one of the search results to navigate to a web page about various types of root canal procedures, (c) views, on the root canal web page, an ad served by the advertisement system 14 advertising a local dentist, (d) clicks a selectable indicator (e.g., a telephone icon) included in the ad, (e) views the temporary telephone number for the local dentist, and (f) dials the temporary telephone number for the local dentist. The advertisement system 14, in accordance with an embodiment of the present invention, receives the incoming phone call, which has been placed by the user to the assignable telephone number 30 currently assigned to the advertiser 54 associated with the ad that was displayed to the user on the root canal web page. Upon receiving the incoming phone call, the advertisement system 14 generates, using at least one processor, a short automated message stating, “The current caller was referred to your ad after searching the terms ‘root canal’ in a web search conducted by ‘Yahoo.com.’ The user is calling from a telephone number with area code ‘617’, which is from the Boston area.” In this manner, the local dentist (or other POC receiving the local dentist's calls in response to the ad) can be informed in advance that the incoming telephone call was placed by a user searching for “root canal” (e.g., as opposed to “teeth cleaning” or other dental services).

In general, the temporary telephone numbers can have any suitable telephone lifetime, as would be appreciated by one of skill in the art upon reading the present specification. In some embodiments, the advertisement system 14 is configured to provide each temporary telephone with a telephone lifetime equal to a predetermined amount of time. Accordingly, for illustrative embodiments utilizing the assignable telephone numbers 30, each telephone assignment can automatically expire once the predetermined amount of time has been reached. For example, the total assignment lifetime 34 can be equal to thirty minutes for each telephone assignment, such that each assigned assignable telephone number 30 automatically becomes unassigned at exactly thirty minutes from the time at which the assignment was made. As such, in such example embodiments, each advertiser's temporary telephone number lasts for a predetermined (e.g., fixed) period of thirty minutes.

The telephone lifetimes of the temporary telephone numbers alternatively may terminate once one or more other criteria are satisfied. In accordance with an example embodiment of the present invention, the advertisement system 14 is configured to provide each temporary telephone number with a telephone lifetime that expires once a predetermined quantity of telephone calls are placed to the temporary telephone number. For example, each temporary telephone number can automatically expire as soon as a single telephone call has been placed to the temporary telephone number. As another example, each temporary telephone number can automatically expire once two telephone calls have been placed to the temporary telephone number. Accordingly, for illustrative embodiments utilizing the assignable telephone numbers 30, the assignment lifetime 34 of each telephone assignment can terminate once the predetermined (e.g., fixed) number of calls has been placed to the assignable telephone number 30. One of skill in the art, with the benefit of the present description, will appreciate that more complex assignment lifetime definitions and implementations, such that the present invention is by no means limited to the specific illustrative examples mentioned herein.

In accordance with example embodiments of the present invention, combinations of criteria and/or conditional criteria are utilized. For example, the advertisement system 14 can be configured such that each temporary telephone number expires upon the sooner of: (a) a predetermined amount of time (e.g., thirty minutes from the time the temporary telephone number was generated), or (b) a predetermined number of telephone calls (e.g., one telephone call). Accordingly, for embodiments utilizing the assignable telephone numbers 30, the length of the assignment lifetime 34 can be variable and not fixed (e.g., not predetermined). Rather, the length of the assignment lifetime 34 (and thus the telephone lifetime of the temporary telephone number) can be equal to the amount of time that passes until one of the two criteria (a) or (b) is satisfied. In such example embodiments described herein, the assignment lifetime 34 can terminate within the predetermined amount of time.

The present invention has been described herein with reference to example embodiments in which each temporary telephone number is presented in and associated with only a single impression of an ad during its telephone lifetime. However, in alternative embodiments, each temporary telephone number can be presented in and associated with two or more ad impressions in its telephone lifetime. In such embodiments that further utilize the assignable telephone numbers 30, each telephone assignment can be associated (e.g., in the data storage 16) with each of the ad impressions in which the assignable telephone number 30 is presented. For example, if e.g., a restaurant, is expressly concerned only with the geographical region of users responding to its ads, then the system could be constrained such that it shows existing temporary telephone numbers to users having the same zip code (or other geographical indicator(s)).

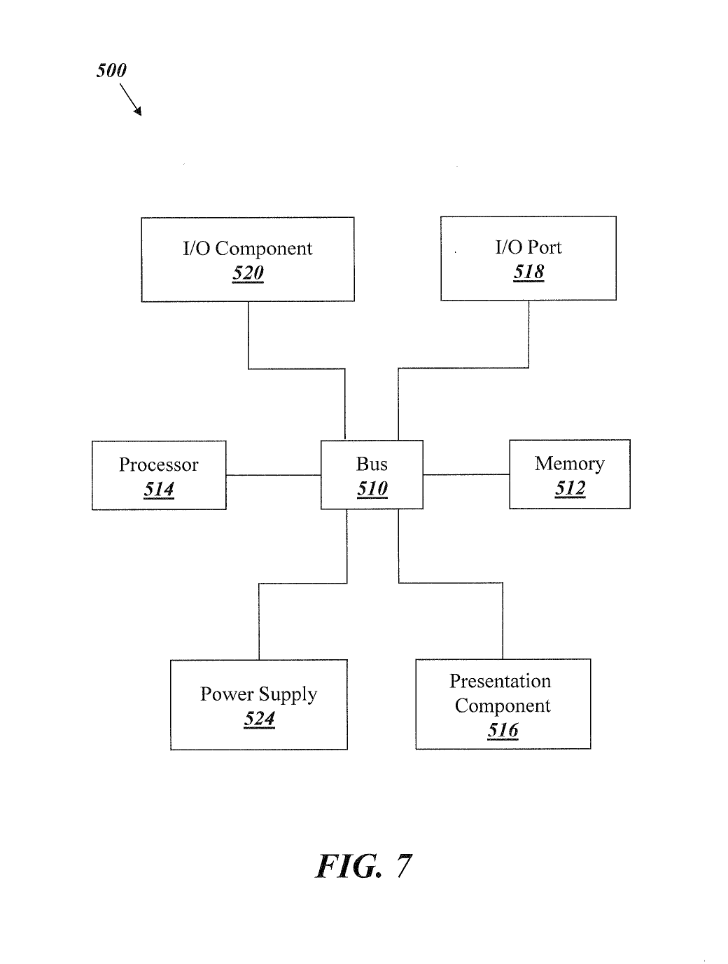

In general, any suitable computing devices can be used to implement the system 10 and the methods described herein. For example, FIG. 7 illustrates an example of a computing device 500 for implementing illustrative methods and systems of the present invention. The computing device 500 is merely an illustrative example of a suitable computing environment and in no way limits the scope of the present invention. A “computing device,” as represented by FIG. 7, generally can include a personal computer, a workstation computer, a laptop, a desktop, a hand-held device, a mobile device, a cellular device, a smartphone device, a tablet computer, a palmtop computer, a set top box, or any other computing device, as would be understood by those of skill in the art. Given that the computing device 500 is depicted for illustrative purposes, embodiments of the present invention may utilize any number of computing devices 500 in any number of different ways. Accordingly, embodiments of the present invention are not limited to a single type of implementation or configuration of the example computing device 500.

The computing device 500 can include a bus 510 that can be coupled to one or more of the following illustrative components, directly or indirectly: a memory 512, one or more processors 514, one or more presentation components 516, input/output ports 518, input/output components 520, and a power supply 524. One of skill in the art will appreciate that the bus 510 can include one or more busses, such as an address bus, a data bus, or any combination thereof. One of skill in the art additionally will appreciate that, depending on the intended applications and uses of a particular embodiment, multiple of these components can be implemented by a single device. Similarly, in some instances, a single component can be implemented by multiple devices. As such, FIG. 7 is merely illustrative of an exemplary computing device that can be used to implement one or more embodiments of the present invention, and in no way limits the invention.

The computing device 500 can include or interact with a variety of computer-readable media. For example, computer-readable media can include Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices that can be used to encode information and can be accessed by the computing device 500.

The memory 512 can include computer-storage media in the form of volatile and/or nonvolatile memory. The memory 512 may be removable, non-removable, or any combination thereof. Exemplary hardware devices are devices such as hard drives, solid-state memory, optical-disc drives, and the like. The computing device 500 can include one or more processors that read data from components such as the memory 512, the various I/O components 520, etc. Presentation component(s) 516 present data indications to a user or other device. Exemplary presentation components include a display device, speaker, printing component, vibrating component, etc.

The I/O ports 518 can allow the computing device 500 to be logically coupled to other devices, such as I/O components 520. Some of the I/O components 520 can be built into the computing device 500. Examples of such I/O components 520 include a microphone, joystick, recording device, game pad, satellite dish, scanner, printer, wireless device, networking device, and the like.

One of skill in the art will appreciate a wide variety of ways to modify and alter the system 10 of FIG. 1, as well as the various components with which it interacts. For example, the data storage 16 can be implemented according to any number of data storage mechanisms (e.g., databases, data stores, log files, etc.). Furthermore, some or all of the information contained in the data storage 16 alternatively can be stored in remote data storage (e.g., cloud data storage, virtual data storage, and any other remote data storage). Additionally, although the components of FIG. 1 are depicted as discrete blocks and elements, in fact the system 10 may be implemented in such a way that multiple of the depicted modules or other components are implemented with just a single module. Moreover, in some embodiments it may be desirable to implement the system 10 using multiple iterations of the depicted modules and/or other components, as would be appreciated by one of skill in the art upon reading the present specification. In addition, while some modules and/or components are depicted as included within the advertisement system 14, it should be understood that, in fact, such modules and/or components alternatively can be excluded from the advertisement system 14.

Likewise, modules and/or components depicted as lying outside the advertisement system 14 alternatively can be included in the advertisement system 14. For example, in some embodiments according to the present invention, the advertisement system 14 is adapted to be a communications service provider (CSP) that provides the assignable telephone numbers 30 and the associated telephone lines. As such, one or more network nodes and/or network devices forming some or all of the communication network(s) 26 can be included in the advertisement system 14. Alternatively, in other embodiments, the assignable telephone numbers 30 are provided by a CSP that is separate from the advertisement system 14. In such embodiments, the advertisement system 14 can be configured to automatically purchase and sell leases on the assignable telephone numbers 30, e.g., based on historical data of usage of the assignable telephone numbers 30 and projections for future usage.

One of skill in the art will appreciate a variety of ways to expand, reduce, or otherwise modify the system 10 upon reading the present specification. All such alternatives and modifications are contemplated within the scope of the present invention.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A computer-implemented method for tracking advertisements, comprising:
receiving, through an input device and from a user device, a request to present a telephone number on the user device in conjunction with an impression of an advertisement;
based on the received request, at least one processor assigning a telephone number to an advertiser associated with the advertisement, the assigned telephone number having an assignment lifetime during which any incoming telephone call to the assigned telephone number is automatically routed to a point of contact of the advertiser;
at least one processor associating the assigned telephone number with the impression of the advertisement in one or more non-transitory machine readable storage devices; and
an output device outputting the assigned telephone number to the user device, whereby the assigned telephone number is caused to be displayed in conjunction with the impression of the advertisement.

2. The computer-implemented method of claim 1, wherein the step of assigning the telephone number comprises selecting a currently unassigned telephone number from a plurality of assignable telephone numbers in the one or more non-transitory machine readable storage devices.

3. The computer-implemented method of claim 1, wherein during the assignment lifetime of the assigned telephone number, the assigned telephone number is only caused to be displayed in conjunction with a predetermined quantity of advertisement impressions.

4. The computer-implemented method of claim 3, wherein the predetermined quantity of advertisement impressions is one advertisement impression.

5. The computer-implemented method of claim 1, wherein the assignment lifetime automatically expires upon one or more predetermined criteria being satisfied.

6. The computer-implemented method of claim 5, wherein the one or more predetermined criteria comprise passage of a predetermined amount of time.

7. The computer-implemented method of claim 5, wherein the one or more predetermined criteria comprise a predetermined quantity of telephone calls being placed to the assigned telephone number.

8. The computer-implemented method of claim 1, further comprising, prior to the step of receiving the request to present the telephone number, an output device outputting the advertisement to produce the impression; wherein the request to present the telephone number is received as a result of a selectable indicator included in the advertisement being selected on the user device.

9. The computer-implemented method of claim 1, further comprising, simultaneous with the step of outputting the assigned telephone number, an output device outputting the advertisement to produce the impression of the advertisement.

10. A computer-implemented advertisement system, comprising:
an input device configured to receive requests from user devices;
at least one non-transitory machine readable storage device configured to store information pertaining to assignments of telephone numbers;
an assignment module configured to cause at least one processor to assign a telephone number to an advertiser based on a received request from a user device to present a telephone number on the user device in conjunction with an impression of an advertisement associated with the advertiser;
a tracking module configured to cause at least one processor to associate the assigned telephone number with the impression of the advertisement in the at least one non-transitory machine readable storage device; and
an output device configured to output the assigned telephone number to the user device, such that the assigned telephone number is presented on the user device;
wherein the computer-implemented advertisement system is configured such that the assigned telephone number has an assignment lifetime, during which any incoming telephone call to the assigned telephone number is automatically routed to a point of contact of the advertiser assigned to the assigned telephone number.

11. The computer-implemented advertisement system of claim 10, wherein the assignment module is configured to assign the telephone number by selecting a currently unassigned telephone number from a plurality of assignable telephone numbers stored in the at least one non-transitory machine readable storage device.

12. The computer-implemented advertisement system of claim 10, wherein the computer-implemented advertisement system is configured in such a way that during the assignment lifetime of the assigned telephone number, the assigned telephone number is only caused to be displayed in conjunction with a predetermined quantity of advertisement impressions.

13. The computer-implemented advertisement system of claim 12, wherein the predetermined quantity of advertisement impressions is one impression.

14. The computer-implemented advertisement system of claim 10, wherein the computer-implemented advertisement system is configured in such a way that the assignment lifetime of the assigned telephone number automatically expires upon one or more predetermined criteria being satisfied.

15. The computer-implemented advertisement system of claim 14, wherein the one or more predetermined criteria comprise passage of a predetermined amount of time.

16. The computer-implemented advertisement system of claim 14, wherein the one or more predetermined criteria comprise a predetermined quantity of telephone calls being placed to the assigned telephone number.

17. The computer-implemented advertisement system of claim 10, wherein the computer-implemented advertisement system is configured to output, through the output device and to the user device, the advertisement with a selectable indicator that, when selected on the user device, results in the user device sending the request to present the telephone number to the computer-implemented advertisement system.

18. The computer-implemented advertisement system of claim 10, wherein the computer-implemented advertisement system is configured to output, through the output device and to the user device, the advertisement with the assigned telephone number, thereby presenting the assigned telephone number in conjunction with the impression of the advertisement.

19. The computer-implemented advertisement system of claim 10, further comprising an ad serving module configured to cause at least one processor to select advertisements to display to user devices and configured to cause at least one output device to output the selected advertisements to the user devices.

20. The computer-implemented advertisement system of claim 19, wherein the user device further comprises a browser client configured to receive the outputted selected advertisements.
